(19) United States
(12) Patent Application Publication
(10) Pub. No.: US 2026/0161999 A1
(43) Pub. Date: Jun. 11, 2026

(54) HETEROGENEOUS INFERENCE ACCELERATION

(71) Applicants: ATI Technologies ULC, Markham (CA); XILINX, INC., San Jose, CA (US)

(72) Inventors: Gabor SINES, Markham (CA); Elliott DELAYE, San Jose, CA (US); Vinod KATHAIL, San Jose, CA (US)

(21) Appl. No.: 18/970,357

(22) Filed: Dec. 5, 2024

(51) Int. Cl. G06N 20/00

(52) U.S. Cl. CPC G06N 20/00

(57) ABSTRACT

The embodiments herein describe techniques for performing ML compilation using a unified interface that combines different processors in a heterogeneous processing system which allows for intelligent partitioning of a ML model. Unlike prior solutions which rely on user preferences to assign the ML model, the unified interface can violate or break the user preferences when partitioning the ML model. The unified interface can receive information from the processors (e.g., a NPU, CPU, GPU, etc.) and determine the capabilities, current workload, power metrics, subgraphs of the ML model they can execute, and the like. With this information, the unified interface can intelligently choose when to violate or break the user-entered priority based instructions.

### TECHNICAL FIELD

The embodiments presented herein relate to deploying a ML model on a heterogeneous processing system.

### BACKGROUND

In applications that want to use machine learning (ML) acceleration, often there is a challenge when deciding how to use an accelerator because each accelerator often has varying levels of operator support, varying levels of performance, and varying levels of device utilization. Currently, an application developer has to choose upfront the set of devices they want to use, and in some cases, list them in order of preference. The selection becomes complex when they want their application to support (i.e., be executable on) a variety of computing devices, that may or may not have a graphics processing unit (GPU), a central processing unit (CPU) acceleration libraries, or a neural processing unit (NPU). In addition, as models change and device software improves, the logic for supporting different computing devices may change so it is infeasible to put this kind of logic into an application.

### SUMMARY

One embodiment described herein is a computing device that includes a heterogeneous processing system comprising different types of processors and one or more memory storing one or more applications executable by one or more of the different types of processors to perform operations. The operations include receiving a user instruction for deploying a machine learning (ML) model in the heterogeneous processing system, receiving operational feedback regarding capabilities of the different types of processors, generating, based on the operational feedback, a deployment strategy for the ML model that violates the user instruction, and deploying the ML model to the heterogeneous processing system according to the deployment strategy.

One embodiment described herein is a non-transitory computer-readable storage medium having computer-readable program code, the computer-readable program code executable by a heterogeneous processing system to perform operations. The operations include receiving a user instruction for deploying a machine learning (ML) model in the heterogeneous processing system, receiving operational feedback regarding capabilities of the different types of processors, generating, based on the operational feedback, a deployment strategy for the ML model that violates the user instruction, and deploying the ML model to the heterogeneous processing system according to the deployment strategy.

One embodiment described herein is a computing device that includes a heterogeneous processing system comprising different types of processors and one or more memory storing one or more applications executable by one or more of the different types of processors to perform operations. The operations include receiving a user instruction for deploying a machine learning (ML) model in the heterogeneous processing system; receiving capabilities of the different types of processors in the heterogeneous processing system; receiving performance and power metrics of the different types of processors in the heterogeneous processing system; receiving subgraphs indicating portions of a graph of the ML model each of the different types of processors can execute; generating, based on the user instruction, the capabilities of the different types of processors, the performance and power metrics, and the subgraphs, a deployment strategy for the ML model; and deploying the ML model to the heterogeneous processing system according to the deployment strategy.

### BRIEF DESCRIPTION OF DRAWINGS

FIG. 1 illustrates a computing device with a heterogeneous processing system, according to one embodiment herein.

FIGS. 2A-2C illustrate different deployments of a ML model on a heterogeneous processing system, according to embodiments herein.

FIG. 3 illustrates a flowchart for deploying a ML model onto a heterogeneous processing system, according to one embodiment herein.

FIG. 4 illustrates a flowchart for partitioning and deploying a ML model onto a heterogeneous processing system, according to one embodiment herein.

FIG. 5 illustrates different subgraphs of a ML model that can be executed by different processors in a heterogeneous processing system, according to one embodiment herein.

FIG. 6 illustrates selecting subgraphs of a ML model to execute on different processor in a heterogeneous processing system, according to one embodiment herein.

FIG. 7 illustrates subgraph fusion, according to one embodiment herein.

### DETAILED DESCRIPTION

The embodiments herein describe techniques for performing ML compilation using a unified interface that combines different processors in a heterogeneous processing system and software backends which allows for intelligent partitioning of a ML model across the different processors. Unlike prior solutions which rely on user preferences to assign the ML model, the unified interface can violate or break the user preferences when partitioning the ML model. For example, a user may instruct that the ML model should first be assigned to the NPU, but if it is not available, to the GPU, but if it is not available, to the CPU. The unified interface can receive information from the processors (e.g., the NPU, CPU, GPU, etc.) and determine their capabilities, current workload, power metrics, subgraphs of the ML model they can execute, and the like. With this information, the unified interface can determine that even though, for example, the NPU is available, it would be better for the ML model to be shared between the GPU and the NPU, where the NPU performs a first phase of the ML model and the GPU performs a second phase of the ML model. Or the unified interface may determine, because the computing device is running on battery power, the ML model should be executed on the NPU to conserve power even though the GPU is available (and the user instructed the ML model to be run on the GPU). In this manner, the unified interface can intelligently choose when not to perform the user-entered priority based instructions. However, the embodiments herein can intelligently partition the model based on system and operating characteristics even if the unified interface does not receive any user input.

In one embodiment, deciding how to partition the ML model is performed in multiple phases. The unified interface can receive the user instructions or preferences (e.g., priority based partitioning) in a first phase. These preferences may set without the user knowing the actual details of the heterogeneous processing system. That is, the application developer may specify the priority base partitioning based on what the developer believes would be the best hardware to execute the ML model. However, the ML model may be deployed on different computing devices that may not have some of the processors stipulated by the developer (or have ones that were not listed by the developer). Additionally, the application developer may be incorrect on their guess on which processors the ML model would be best deployed on.

In later phases, the unified interface can detect the capabilities of the processors in the heterogeneous processing system and receive performance and power metrics of those processors. In addition, in one phase the processors can indicate which portions (i.e., subgraphs) of the graph representing the ML model can be executed on each processor in the heterogeneous processing system, which can be used to decide whether the ML model should be executed on one, or multiple processors. In one embodiment, the unified interface can perform sub-graph fusion where multiple processors can be “fused” together using shared memory which, to the perspective of the ML runtime, appears that one processor is executing the fused sub-graphs when in reality the unified interface has partitioned the ML model to execute on multiple processors. In this manner, the unified interface (which logically exists between the ML runtime and the backend for the processor) can use multi-phase partitioning to decide how to deploy a ML model in a heterogeneous processing system in a computing device.

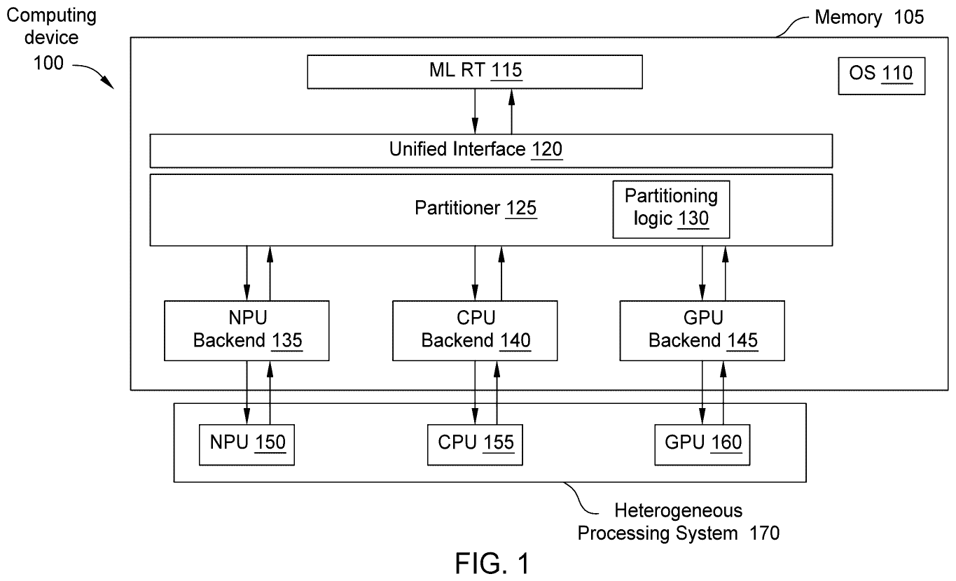

FIG. 1 illustrates a computing device 100 with a heterogeneous processing system 170, according to one embodiment herein. The computing device 100 (e.g., a server, laptop, desktop, etc.) includes memory 105 and the heterogeneous processing system 170. The memory 105 can include volatile memory elements, nonvolatile memory elements, and combinations thereof. In this example, the memory 105 includes an operating system (OS) 110 which can execute various software applications such as a ML runtime (RT) 115, a unified interface 120, a partitioner 125, a NPU backend 135, a CPU backend 140, and a GPU backend 145.

In one embodiment, the ML RT 115 is a RT to execute specific files that use a common format for defining ML models. These files can define a common set of operators that form the building blocks of ML and deep learning. For example, the ML RT 115 can permit models to be transferred between different frameworks, such as PyTorch and TensorFlow without retraining or major modifications. For instance, the ML RT 115 can permit a ML model to be trained in one framework (e.g., PyTorch) but deployed in another framework (e.g., Java). The embodiments herein are not limited to any particular ML RT, as there are a variety of different suitable ML RTs, which can be open-source or closed source RTs.

The unified interface 120 provides a single interface (e.g., an application programming interface (API)) from the ML RT 115 to the backends 135, 140, 145. Without the unified interface 120, the ML RT 115 would have different APIs for the different backends 135, 140, 145. Without the unified interface 120, the ML RT 115 would choose only one of the backends to use to deploy the ML model. That is, the ML RT 115 does not have a way to intelligently decide to partition an ML Model across the processors in the heterogeneous processing system 170. Instead, an application developer (e.g., a user) would have to explicitly tell the ML RT 115 how to partition the ML model, but as discussed above, the application developer may have little knowledge about the processors in the heterogeneous processing system 170.

Moreover, backends 135, 140, 145 may have different intermediate representations (IRs), which is the description of the ML model in a RT or a compiler. Thus, moving work from one backend to another backend would require translation between the different IRs.

These issues are resolved when the unified interface 120 (and the partitioner 125) are added in the runtime stack. The unified interface 120 and the partitioner 125 can automatically determine an optimal deployment of the ML model in the heterogeneous processing system 170. In fact, the deployment may contradict or violate the priority based partitioning set by the application developer. Moreover, the unified interface 120 does not have to translate between the IRs used by the different backends 135, 140, 145. The unified interface 120 can use existing inputs that are already supported by the ML RT 115. The unified interface 120 can transmit the instructions to the respective backends 135, 140, 145 that can perform their respective translations.

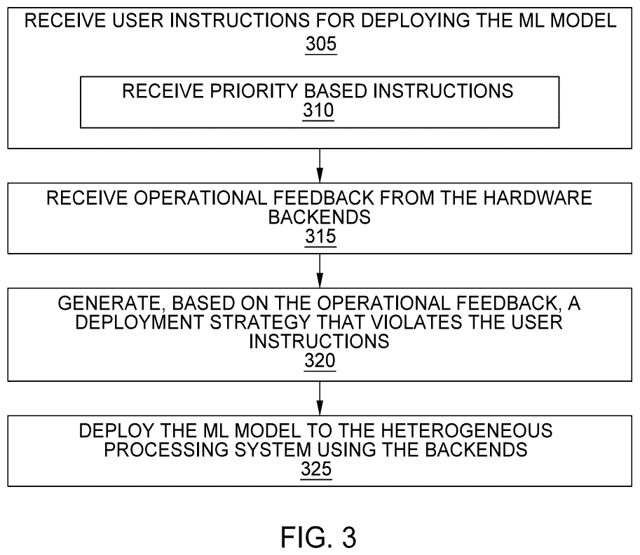

The partitioner 125 includes partitioning logic 130 which communicates with the backends 135, 140, 145 (in one or more phases) to determine how the ML model should be deployed on the heterogeneous processing system 170. The details of this process is discussed in more detail in FIGS. 3-7.

The backends 135, 140, 145 can be referred to as Execution Providers (EP) 125, and the ML RT 115 can be software applications that are executed by the OS 110 and the CPU 155. The unified interface 120 can send instructions to the backends 135, 140, 145 which in turn offload the job of executing the ML model to the processors in the heterogeneous processing system 170.

In this example, the heterogeneous processing system 170 includes an NPU 150, CPU 155, and GPU 160, but this is just one example of a heterogeneous processing system 170. In other implementations, a heterogeneous processing system 170 may include only the CPU and the GPU, or only the CPU and the NPU. Moreover, the heterogeneous processing system 170 can include more processors than the ones shown (e.g., a system on a chip (SoC) that implements an AI accelerator, or a field programmable gate array (FPGA)). In general, the heterogeneous processing system 170 can include any number of processors where at least two of the processors are different types.

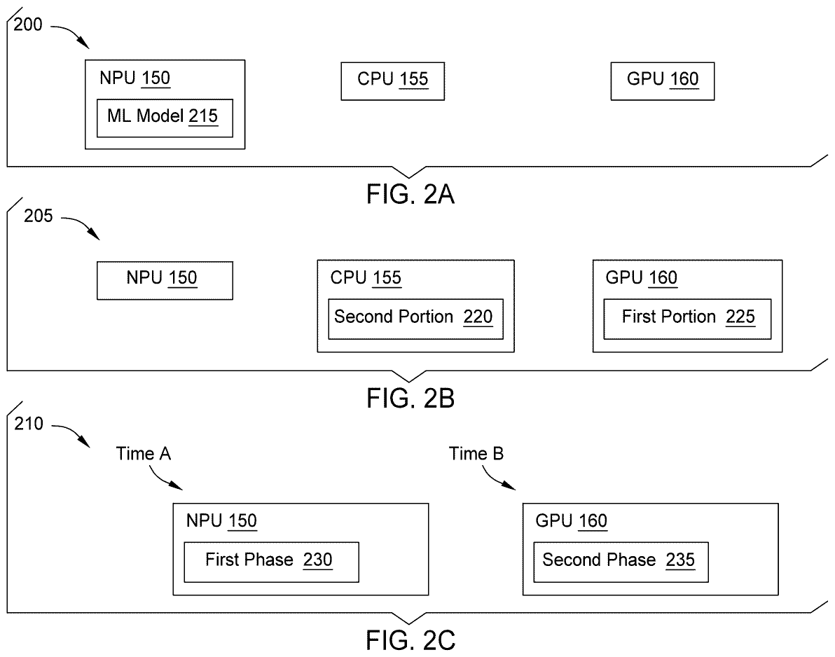

FIGS. 2A-2C illustrate different deployments of a ML model on a heterogeneous processing system, according to embodiments herein. FIG. 2A illustrates a deployment 200 where the unified interface (e.g., the unified interface 120 in FIG. 1) uses the backends (e.g., the backends 135, 140, 145 in FIG. 1) to deploy a ML model 215 onto the NPU 150. That is, in this example, the ML model 215 executes on the NPU 150, and not on the GPU 160 and the CPU 155. As shown, the unified interface offloads the entire ML model 215 to one of the target architectures in the heterogeneous processing system (e.g., the NPU 150). As an example where this may be preferred is video conferencing where the NPU can run ML models for face detection at a constant 30 or 60 fps matching the video stream frame rates while the GPU and CPU might be running high intensity compute and graphics such as gaming and could induce variable amounts of latency depending on dynamic load.. Advantageously, data communication between the target architecture is at a model level, and hence, there is less impact on the overall performance.

FIG. 2B illustrates a deployment 205 where the unified interface uses the backends to deploy a first portion 225 of the ML model 215 onto the GPU 160 and a second portion 220 of the ML model 215 onto the CPU 155. Here, a part of the ML model is offloaded to one target architecture and other parts are offloaded to one or more other target architectures. Reasons for splitting the ML model as shown in FIG. 2B can include because some operator types in the ML model 215 can be performed on one processor, but not others, or because of the compute and memory bandwidth requirements of the ML model 215. For example, embedding lookups, which are indirect, can be performed on the CPU 155 while other compute heavy-operators are performed on the NPU or GPU.

While using different target architectures can have a negative impact on performance (due to data communication being at each operator level), this can be mitigated by using compatible device level drivers for zero copy data transfer between the GPU and NPU. It may be more beneficial to offload large subgraphs (which are discussed in more detail in below) to different target architectures.

FIG. 2C illustrates a deployment 210 where the unified interface uses the backends to deploy a first phase 230 of the ML model 215 onto the NPU 150 and a second phase 235 of the ML model 215 onto the GPU 160. These phases can execute at different time periods. For example, at Time A, the NPU 150 executes the first phase 230 where the processed data is then transmitted to the GPU 160 to execute the second phase 235 at Time B. FIG. 2C represents that a unified interface can distribute any number of different phases of the ML model 215 to any number of target architectures. In one embodiment, the distribution of the phases is based on each phases'compute and memory bandwidth and capacity requirements. For example, for a large language model (LLM), the compute-heavy prompt phrase can execute on the NPU 150 and the bandwidth-heavy token phase on the GPU 160.

In this example, data communication is at a phase level, so there may be less impact on performance than in FIG. 2B. Moreover, the ML model can have a way to mark the execution phases. For example, for LLM, tensor shapes can be used as the indication to mark different phases.

FIG. 3 illustrates a flowchart of a method 300 for deploying a ML model onto a heterogeneous processing system, according to one embodiment herein. For example, the method 300 can be used to result in any of the deployments illustrated in FIGS. 2A-2C.

At block 305, the unified interface receives user instructions for deploying the ML model. For example, the user (e.g., an application developer or a customer) provides her partitioning input using session parameters that are part of the ML RT. In one embodiment, the partitioner gives preference to the user input, however, the user input can be overridden or violated as will be discussed at block 320.

The user instruction can include a full model level where the user chooses a specific target architecture or specific device (e.g., the GPU) for the ML model.

In one embodiment, the user can specify the different nodes in a graph of the ML model that should be executed on a particular target architecture. For example, the nodes in the graph for the ML model can have node names or node numbers. In the session parameters for the ML RT, the user can use the node names or numbers to specify which nodes in the graph should be executed on a particular target architecture. For example, the user may specify in a GPU operator list that the nodes 10, 20, 30, and 40 in the graph of the ML model should be executed on the GPU.

In one embodiment, at sub-block 310, the unified interface receives priority based instructions from the user (referred to as priority based partitioning). For example, the user instructions can list the priority for deploying the ML model such as first attempting to deploy the ML model on the GPU, but if it is too busy, then the NPU, but if it is too busy, then the CPU.

In another embodiment, the user input includes performance targets which the unified interface would attempt to meet given the system static and dynamic characteristics.

However, the embodiments herein can be used even if there are no user instructions received by the unified interface. For example, the unified interface may have a default priority based partitioning.

At block 315, the unified interface receives operational feedback from the hardware backends (e.g., the backends 135, 140, 145 in FIG. 1). The operational feedback can include the unified interface detecting what types of processors are in the heterogeneous processing system, the types of ML operators (e.g., matmuls, convolution, maxpool, avgpool, etc.) and datatypes (e.g., integer, floating point, block floating point, etc.) each processor can and cannot perform, a shape range of the ML operators supported by each processor (e.g., the size of data that can be handled by the hardware when performing a particular operation), the currently available compute for each processor, the power metrics for each processor, metadata specifying the mapping of shapes or phases of ML models to a particular processor (e.g., which processor is better at executing a prompt phase versus a token phase), and the like.

In addition, the operational feedback can include receiving subgraphs indicating portions of the graph of the ML model that each processor is capable of executing. Moreover, the subgraphs can be fused together so that multiple processors can use shared memory to behave like a single processor.

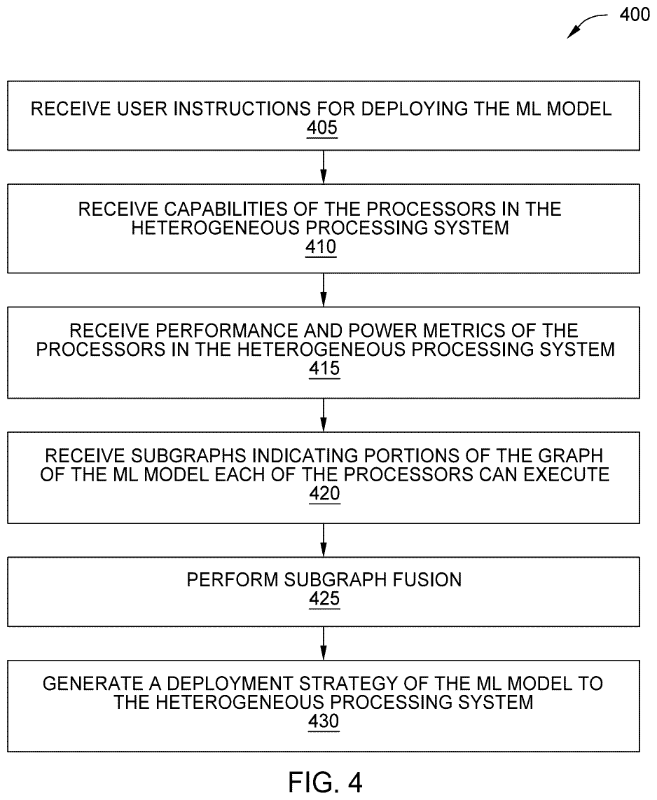

The operational feedback can include any of the metrics discussed above, in any combination, in addition to similar metrics. In one embodiment, the partitioner can perform multiple phases to consider these metrics and determine a deployment for the ML model. One such example is discussed in FIG. 4 which is discussed in more detail below. Moreover, FIG. 4 describes many of these metrics in more detail.

At block 320, the partitioner generates, based on the operational feedback, a deployment strategy that violates the user instructions. That is, when gathering the operational feedback at block 315, the partitioner can determine that it should not follow the user instructions received at block 305, even though the computing system may have the ability to deploy the ML model as instructed by the user. For example, the user may have instructed the ML RT, using priority based partitioning, that her first choice for the ML model is the GPU. However, the partitioner can learn from the operational feedback that the computing system (e.g., a laptop) is running on battery power, or that the GPU has less than the required compute available. Although the ML model could be deployed on the GPU, it may have a disproportionate impact on battery life, or would execute slower than if the ML model was deployed on a different processor. Thus, in this example, the partitioner and the unified interface can decide to violate the priority specified by the user (i.e., break the priority), despite the fact the computing device could follow the priority but decides not to in order to obtain a more optimal result.

At block 325, the unified interface deploys the ML model to the heterogeneous hardware platform using the backends. The deployments can include any of the three scenarios illustrated in FIGS. 2A-2C. That is, the ML model can be deployed to one of the processors in the heterogeneous hardware or multiple processors in the heterogeneous hardware. Further, if deployed on multiple processors, the multiple processors may execute different portions of the ML model concurrently, or could execute different phases of the ML model sequentially.

FIG. 4 illustrates a flowchart of a method 400 for partitioning and deploying a ML model onto a heterogeneous processing system, according to one embodiment herein. At block 405, the unified interface receives user instructions for deploying the ML model. For example, the user instructions may be passed to the unified interface from the ML RT.

Different examples of user instructions (including priority based partitioning) were discussed in block 305 in FIG. 3, and are not discussed again here.

At block 410, the partitioner receives capabilities of the processors in the heterogeneous processing system. In one embodiment, as part of this process, the partitioner can identify the different processors in the heterogeneous processing system - e.g., determine whether the computing device has a CPU, NPU, GPU, etc. That is, one part of partitioning can be detecting the different backends and processors in the computing device. This is advantageous because a user may tell the ML RT to use a specific processor to execute the ML model, but if the computing device does not have that processor, the launch RT will fail. However, with the unified interface and partitioner described herein, it can fall back to a different type of processor if the specified processor does not exist in the heterogeneous processing system.

The partitioner can transmit a request (e.g., “GetCapability”) to each of the backends to determine the capabilities of the processors. For example, the processors may indicate which type of operators in a ML model (e.g., matmul, conv-2d, maxpool, etc.) they can execute and which they cannot. Moreover, the processors can indicate the shape of data they can handle. The shape generally refers to the size of the data, which can include its dimensions. For instance, in addition to informing the partitioner of the operators the processors can perform, the respective backends can indicate the shape range of those operations. For example, a first type of processor may be capable of doing matmuls, but only up to a matrix size of 100×100, but a second type of processor may be capable of doing matmuls for matrix sizes up to 10,000×10,000.

In one embodiment, the backends can provide metadata indicating a specific mapping of shapes to a particular target processor. For example, the backends can inform the partitioner that if the matrix or vector size (M) is less than a threshold dimension/size (c), the ML model (or a corresponding portion/operation/node of the ML model) should be assigned to the NPU, but if the matrix or vector is greater than the threshold, the ML model (or sub portion thereof) should be assigned to the GPU. At compile, the compiler can return a trampoline partitioner function such as:
compiled_matmul ( . . . ) {
   If (M<c) gpu_compiled_matmul ( . . . )
   Else NPU_compiled_matmul (....)

In this manner, as the shape of the input data changes, the ML RT can change at runtime which processor performs the operation (e.g., the matmul).

The capabilities can also include the types of data the processors can process for a particular operation (e.g., integer8, integer 32, float8, float16, block floating points, etc.).

The capabilities of the processors can also include total compute (e.g., TOPs), memory bandwidth, on-chip memory size, maximum/minimum frequency, execution efficiency, and the like.

At block 415, the partitioner receives performance and power metrics of the processors in the heterogeneous processing system. The performance metrics can include information such as the current utilization of the processors (e.g., current load), memory utilization, and the like. The power metrics can include the amount of power consumed by the processors, which could be an average power consumption, or a power consumption at the current workloads.

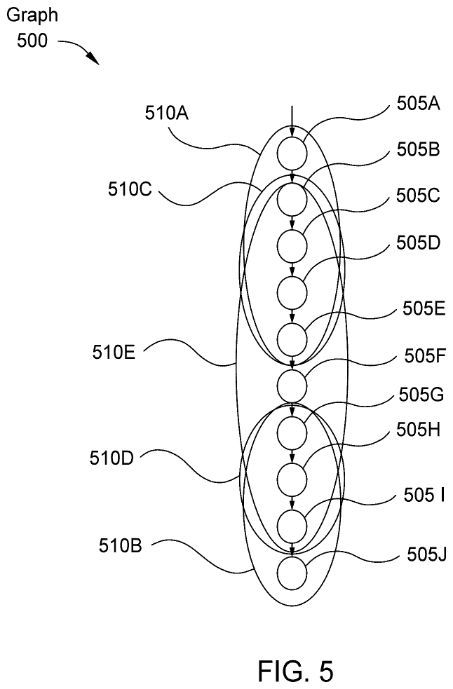

At block 420, the partitioner receives subgraphs indicating portions of the graph of the ML model each of the processors can execute. That is, the ML model can be expressed by a plurality of interconnected nodes, where each node represents a particular ML operation (e.g., a matmul, maxpool, relu, convolution, etc.). Unlike in block 410 where the backends report the types of operators that can be performed, here the backends can provide subgraphs (which include multiple interconnected nodes) indicating what portions of the ML model graph each processor can perform. This is shown graphically in FIG. 5.

FIG. 5 illustrates different subgraphs of a ML model that can be executed by different processors in a heterogeneous processing system. The graph 500 represents a graph of a ML model that includes interconnected nodes 505A-J, which each can represent a ML operator.

The subgraphs 510A and 510B illustrate groups of nodes 505 that can be performed by a first type of processor, e.g., NPU. This means that the NPU cannot execute the nodes of the graph 500 that are not included within the subgraphs 510A and 510B—i.e. node 505F.

The subgraphs 510C and 510D illustrate groups of nodes 505 that can be performed by a second type of processor, e.g., CPU. This means that the CPU cannot execute the nodes of the graph 500 that are not included within the subgraphs 510C and 510D—i.e. nodes 505A, 505F, and 505J.

The subgraph 510E illustrate a group of nodes 505 that can be performed by a third type of processor, e.g., GPU. This means that the GPU cannot execute the nodes of the graph 500 that are not included within the subgraph 510E—i.e. nodes 505A and 505J.

Notably, the subgraphs 510 not only tell which types of operations a particular processor can execute, but also whether the processor can execute groups of operators sequentially. For example, it may be the case that the first type of processor can perform the operation represented by the node 505G in certain scenarios, but not when that node is preceded by the operation represented by node 505F, which is why the node 505G is excluded from the subgraph 510A for the first type of processor.

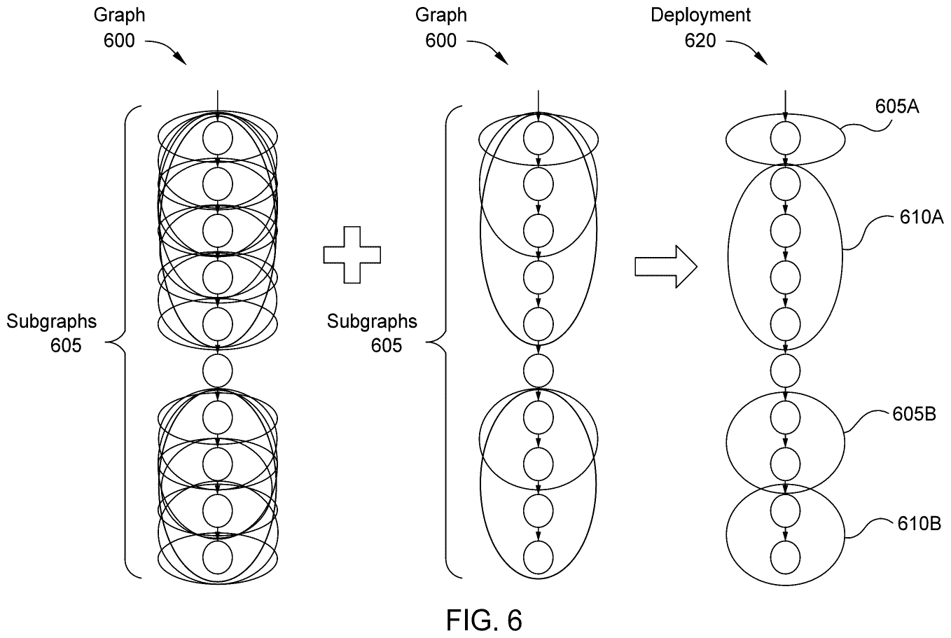

FIG. 6 illustrates selecting subgraphs of a ML model to execute on different processor in a heterogeneous processing system, according to one embodiment herein. FIG. 6 illustrates one example of the partitioner identifying the subgraphs for each processor and then deciding how to deploy the ML model between those processors.

In this example, the subgraphs 605 illustrate the different combinations of the nodes in the graph 600 that can be performed by a first type of processor (e.g., the NPU). The subgraphs 610 illustrate the different combinations of the nodes in the graph 600 that can be performed by a second type of processor (e.g., the GPU). FIG. 6 illustrates that the backends can return multiple overlapping subgraphs for each processor to illustrate the various combinations of nodes that can performed by each processor. Identifying the various overlapping combinations of subgraphs can enable more fine-grain control when mapping the subgraphs to ML model.

The partitioner logic can evaluate the subgraphs 605 and 610 to then generate a deployment 620 of the ML model shown on the right of FIG. 6. the deployment 620 includes subgraphs 605A and 605B which are performed on the first type of processor and subgraphs 610A and 610B which are performed on the second type of processor. In this manner, the partitioner logic can identify the different subgraphs and then select which portions of the graph 600 of the ML model should be assigned to which of the processors, which is also based on the information received at blocks 405, 410, and 415 of the method 400.

Returning to the method 400, at block 425 the partitioner performs subgraph fusion, which can be an optional step. One issue with deploying a ML model across multiple processors based on the subgraphs as shown in FIG. 6 is that this may require copying data between the processors (e.g., using main memory in the computing device), which introduces latency. That is, the ML RT may have to move the data between the different processors.

Instead, subgraph fusion can be performed where subgraphs are fused together and shared memory is used to communicate between the processors whose subgraphs have been fused. In this case, the unified interface tells the ML RT there is a single graph, but internally the unified interface knows there are two subgraphs. A compiler can then instruct the processors to use the shared memory to exchange data between the subgraphs, which reduces latency.

In one embodiment, the subgraph fusion can also reduce dispatch latency by permitting the processors to directly launch the next processor, rather than relying on the CPU/ML RT to move the data between processors operating different subgraphs of the ML model graph. For example, assume a subgraph for a NPU and a GPU are fused. Rather than the NPU doing its operations, storing the output data in main memory, notifying the CPU/ML RT that it is finished, and then the CPU/ML RT launching the GPU, the NPU can directly launch the GPU when it has stored the output data in the shared memory thereby cutting out the ML RT as the middleman.

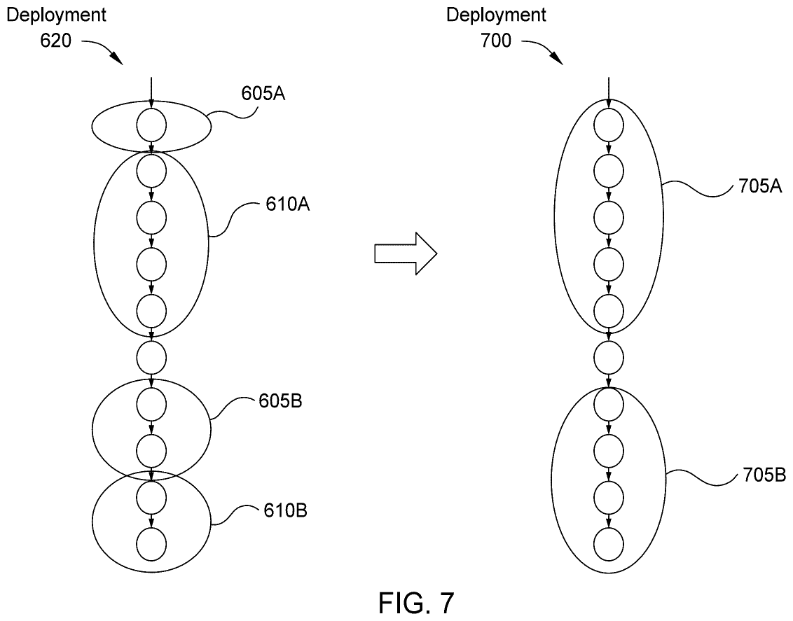

FIG. 7 illustrates subgraph fusion, according to one embodiment herein. FIG. 7 illustrates on the left the deployment 620 shown in FIG. 6 where the nodes in the graph of the ML model are assigned to two different processors in the heterogeneous processing system.

Assuming the computing device has shared memory accessible to both of those processors, the partitioner logic can then perform subgraph fusion to result in a new deployment 700 for the ML model. Here, the subgraphs 605A and 610A have been fused into subgraph 705A and the subgraphs 605B and 610B have been fused into subgraph 705B. Thus, the ML RT only sees two subgraphs which appear to be executed by a single processor although the unified interface knows each of the subgraphs 705 is being executed on two (or more) different types of processors which can use shared memory to exchange data without involving the ML RT to control dispatch. That is, the ML RT may be involved only at the input and output of the fused subgraphs 705, but not when switching between processors within the subgraphs 705.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A computing device comprising:
a heterogeneous processing system comprising different types of processors; and
one or more memory storing one or more applications executable by one or more of the different types of processors to perform operations, the operations comprising:
receiving a user instruction for deploying a machine learning (ML) model in the heterogeneous processing system;
receiving operational feedback regarding capabilities of the different types of processors;
generating, based on the operational feedback, a deployment strategy for the ML model that violates the user instruction; and
deploying the ML model to the heterogeneous processing system according to the deployment strategy.

2. The computing device of claim 1, wherein the user instruction indicates a priority in which the ML model should be deployed on the different types of processors, wherein violating the user instruction comprises violating the priority even though the computing device is capable of satisfying the priority indicated in the user instruction.

3. The computing device of claim 1, wherein receiving the operational feedback comprises:
identifying types of ML operators in the ML model that can be executed by the different types of processors.

4. The computing device of claim 1, wherein receiving the operational feedback comprises:
receiving performance metrics and power metrics of the different types of processors, wherein the performance metrics are associated with a current load and peak performance of the different types of processors and the power metrics are associated with power consumed by the different types of processors.

5. The computing device of claim 1, wherein the ML model is represented by a graph, wherein the graph comprises a plurality of interconnected nodes, wherein the nodes represent ML operators,
wherein receiving the operational feedback comprises:
receiving subgraphs indicating sub-portions of the graph that each of the different types of processors can execute, wherein each of the subgraphs includes multiple interconnected nodes in the graph.

6. The computing device of claim 5, wherein generating the deployment strategy comprises:
using a first subgraph of the subgraphs for a first processor of the different types of processors to execute a first portion of the graph; and
using a second subgraph of the subgraphs for a second processor of the different types of processors to execute a second portion of the graph.

7. The computing device of claim 5, wherein generating the deployment strategy comprises:
performing subgraph fusion to generate a fused subgraph where a first subgraph of the subgraphs for a first processor of the different types of processors is fused with a second subgraph of the subgraphs for a second processor of the different types of processors,
wherein, during runtime when executing the fused subgraph, the first processor exchanges data with the second processor using a shared memory in the computing device.

8. A non-transitory computer-readable storage medium having computer-readable program code, the computer-readable program code executable by a heterogeneous processing system to perform operations, the operations comprising:
receiving a user instruction for deploying a machine learning (ML) model in the heterogeneous processing system comprising different types of processors in a computing device;
receiving operational feedback regarding capabilities of the different types of processors;
generating, based on the operational feedback, a deployment strategy for the ML model that violates the user instruction; and
deploying the ML model to the heterogeneous processing system according to the deployment strategy.

9. The non-transitory computer-readable storage medium of claim 8, wherein the user instruction indicates a priority in which the ML model should be deployed on the different types of processors, wherein violating the user instruction comprises violating the priority even though the computing device is capable of satisfying the priority indicated in the user instruction.

10. The non-transitory computer-readable storage medium of claim 8, wherein receiving the operational feedback comprises:
identifying types of ML operators in the ML model that can be executed by the different types of processors.

11. The non-transitory computer-readable storage medium of claim 8, wherein receiving the operational feedback comprises:
receiving performance metrics and power metrics of the different types of processors, wherein the performance metrics are associated with a current load and peak performance of the different types of processors and the power metrics are associated with power consumed by the different types of processors.

12. The non-transitory computer-readable storage medium of claim 8, wherein the ML model is represented by a graph, wherein the graph comprises a plurality of interconnected nodes, wherein the nodes represent ML operators,
wherein receiving the operational feedback comprises:
receiving subgraphs indicating sub-portions of the graph that each of the different types of processors can execute, wherein each of the subgraphs includes multiple interconnected nodes in the graph.

13. The non-transitory computer-readable storage medium of claim 12, wherein generating the deployment strategy comprises:
using a first subgraph of the subgraphs for a first processor of the different types of processors to execute a first portion of the graph; and
using a second subgraph of the subgraphs for a second processor of the different types of processors to execute a second portion of the graph.

14. The non-transitory computer-readable storage medium of claim 12, wherein generating the deployment strategy comprises:
performing subgraph fusion to generate a fused subgraph where a first subgraph of the subgraphs for a first processor of the different types of processors is fused with a second subgraph of the subgraphs for a second processor of the different types of processors,
wherein, during runtime when executing the fused subgraph, the first processor exchanges data with the second processor using a shared memory in the computing device.

15. A computing device comprising:
a heterogeneous processing system comprising different types of processors; and
one or more memory storing one or more applications executable by one or more of the different types of processors to perform operations, the operations comprising:
receiving a user instruction for deploying a machine learning (ML) model in the heterogeneous processing system;
receiving capabilities of the different types of processors in the heterogeneous processing system;
receiving performance and power metrics of the different types of processors in the heterogeneous processing system;
receiving subgraphs indicating portions of a graph of the ML model each of the different types of processors can execute;
generating, based on the user instruction, the capabilities of the different types of processors, the performance and power metrics, and the subgraphs, a deployment strategy for the ML model; and
deploying the ML model to the heterogeneous processing system according to the deployment strategy.

16. The computing device of claim 15, wherein the deployment strategy violates the user instruction, wherein the user instruction indicates a priority in which the ML model should be deployed on the different types of processors, wherein violating the user instruction comprises violating the priority even though the computing device is capable of satisfying the priority indicated in the user instruction.

17. The computing device of claim 15, wherein the deployment strategy comprises switching between two of the different types of processors in the heterogeneous processing system during two phases of the ML model.

18. The computing device of claim 15, wherein the graph comprises a plurality of interconnected nodes, wherein the nodes represent ML operators, wherein each of the subgraphs includes multiple interconnected nodes in the graph.

19. The computing device of claim 18, wherein generating the deployment strategy comprises:
using a first subgraph of the subgraphs for a first processor of the different types of processors to execute a first portion of the graph; and
using a second subgraph of the subgraphs for a second processor of the different types of processors to execute a second portion of the graph.

20. The computing device of claim 18, wherein generating the deployment strategy comprises:
performing subgraph fusion to generate a fused subgraph where a first subgraph of the subgraphs for a first processor of the different types of processors is fused with a second subgraph of the subgraphs for a second processor of the different types of processors,
wherein, during runtime when executing the fused subgraph, the first processor exchanges data with the second processor using a shared memory in the computing device.
